(19) United States
(12) Patent Application Publication
(10) Pub. No.: US 2010/0309049 A1
(43) Pub. Date: Dec. 9, 2010

(54) DIRECTIONAL DATA DISTRIBUTION

(75) Inventors: Jukka REUNAMÄKI, Tampere (FI); Arto Tapio PALIN, Viiala (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/479,435

(22) Filed: Jun. 5, 2009

(51) Int. Cl. H04B 7/00

(52) U.S. Cl. 342/367

(57) ABSTRACT

A system for facilitating wireless communication in an apparatus that may be triggered by the realization of data for wireless transmission. A determination may then be made as to whether the data is intended for transmission to a certain recipient (e.g., a specific apparatus) or in a specific direction. The data may then be transmitted using directional wireless communication if a wireless transport is determined to be usable for transmitting the data in a direction based on the previous determination. If directional wireless communication is not available, the data may be transmitted via omnidirectional communication.

### BACKGROUND

1. Field of Invention

The present invention relates to the communication of data, and in particular, to data distribution utilizing directional communication and/or wireless transport determination.

2. Background

The variety of applications into which wireless communication features are being incorporated continues to grow. For example, operational situations that formally did not utilize any kind of electronic communication, let alone wireless communication, may now include the capacity to communicate wirelessly in order to provide enhanced functionality for the consumer. Moreover, certain applications that were previously unconceivable, or were deemed too difficult to implement, now exist and flourish due to the applicability of wireless communication.

The aforementioned wireless applications may operate using reserved or shared bandwidth. For example, cellular communication providers operate within a certain bandwidth that is licensed primarily for their use. However, as procuring licensed bandwidth may entail substantial cost due to limited availability, applications that operate in unlicensed bandwidth are increasing in popularity. Many different types of wireless signal-driven activity may take place in this shared bandwidth region including, for example, short-range wireless communication like wireless local area networking (WLAN), Bluetooth, low power transports for remote control, wireless sensors, etc., close-proximity interaction for scanning machine-readable media, etc.

The substantially simultaneous operation of various types of wireless signal-based communication in the unlicensed bands, coupled with non-communication-related signals in the same frequency range that may be generated by other electromagnetic apparatuses, may result in an overly “noisy” operational arena. In particular, not only is it possible for the various types of wireless communication signals to interfere with each other, but generalized interference caused by the operation of other electronic devices may further create interference situations. At least one negative impact of this operational scenario is that any benefits that may be realized through the introduction of wireless functionality into a situation may become somewhat nullified if the quality of service (QoS) is poor, and thus, less attractive for utilization in potential applications.

### SUMMARY

Various example embodiments of the present invention may be directed to a method, apparatus and computer program product for facilitating wireless communication in an apparatus. Various example implementations may be triggered by the realization of data for wireless transmission. A determination may then be made as to whether the data is intended for transmission to a certain recipient (e.g., a specific apparatus) or in a specific direction. The data may then be transmitted using directional wireless communication if a wireless transport is determined to be usable for transmitting the data in a direction based on the previous determination. If directional wireless communication is not available, the data may be transmitted via omnidirectional communication.

In a least one example configuration, a determination may be made as to whether the data is intended for a certain recipient, the result of which may ultimately identify a specific apparatus. In the instance that the apparatus identified is the apparatus with data to transmit, no further transmission would occur (e.g., data is at intended destination). If a specific apparatus is determined to be identified other than the apparatus with data to transmit, a further determination may then be made as to a direction towards the specific apparatus. The direction towards the specific apparatus may be based on, for example, a direction map residing in the apparatus with data to transmit. A direction map may comprise location information for other proximally-located apparatuses derived alone or in combination with location information provided by some or all of the other apparatuses. The direction towards the specific apparatus may then be utilized as the specific direction for transmission using directional wireless communication, if available.

Some example implementations may also employ a further determination as to whether directional wireless communication is supported in an apparatus with data to transmit. The determination may comprise determining which, if any, of the wireless communication transports that are supported in the apparatus with data to transmit are usable for directional wireless communication in the specific direction. If multiple wireless transports are usable, the selection of at least one wireless transport may be based on criteria including, for example, the wireless transports that are supported by the specific (recipient) apparatus or any intermediary apparatuses, required operational parameters (e.g., quality, speed, etc.), apparatus condition, etc.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### DESCRIPTION OF DRAWINGS

The invention will be further understood from the following description of various example embodiments, taken in conjunction with appended drawings, in which:

FIG. 1 discloses an example communication architecture that is usable when implementing the various example embodiments of the present invention.

FIG. 2 discloses an example wireless interaction scenario including a plurality of apparatuses in accordance with at least one embodiment of the present invention.

FIG. 3 discloses an example of directional wireless communication in accordance with at least one embodiment of the present invention.

FIG. 4 discloses an example of applying directional wireless communication to the example of FIG. 2 in accordance with at least one embodiment of the present invention.

FIG. 5 discloses an example direction map in accordance with at least one embodiment of the present invention.

FIG. 6 discloses a multi-level operational example of Network on Terminal Architecture in accordance with at least one embodiment of the present invention.

FIG. 7 discloses an example of a communication structure usable with Network on Terminal Architecture in accordance with at least one embodiment of the present invention.

FIG. 8 discloses and example of a connectivity map usable with Network on Terminal Architecture in accordance with at least one embodiment of the present invention.

FIG. 9A-9C discloses an example of an application querying and selecting a service in accordance with at least one embodiment of the present invention.

FIG. 10A discloses an example of transport selection in accordance with at least one embodiment of the present invention.

FIG. 10B discloses an example integration of a cognitive radio (CR) system into a communication architecture wherein application level entities may interact directly with CR system components in accordance with at least one embodiment of the present invention.

FIG. 11A discloses an example implementation of directional communication and transport selection in accordance with at least one embodiment of the present invention.

FIG. 11B discloses the example implementation of FIG. 10A including a delay feature in accordance with at least one embodiment of the present invention.

FIG. 12A discloses a flowchart for an example data transmission process in accordance with at least one embodiment of the present invention.

FIG. 12B discloses a more detailed flowchart for an example data transmission process in accordance with at least one embodiment of the present invention.

### DESCRIPTION OF EXAMPLE EMBODIMENTS

While the invention has been described below in terms of a multitude of example embodiments, various changes can be made therein without departing from the spirit and scope of the invention, as described in the appended claims.

### I. Example System with Which Embodiments of the Present Invention may be Implemented

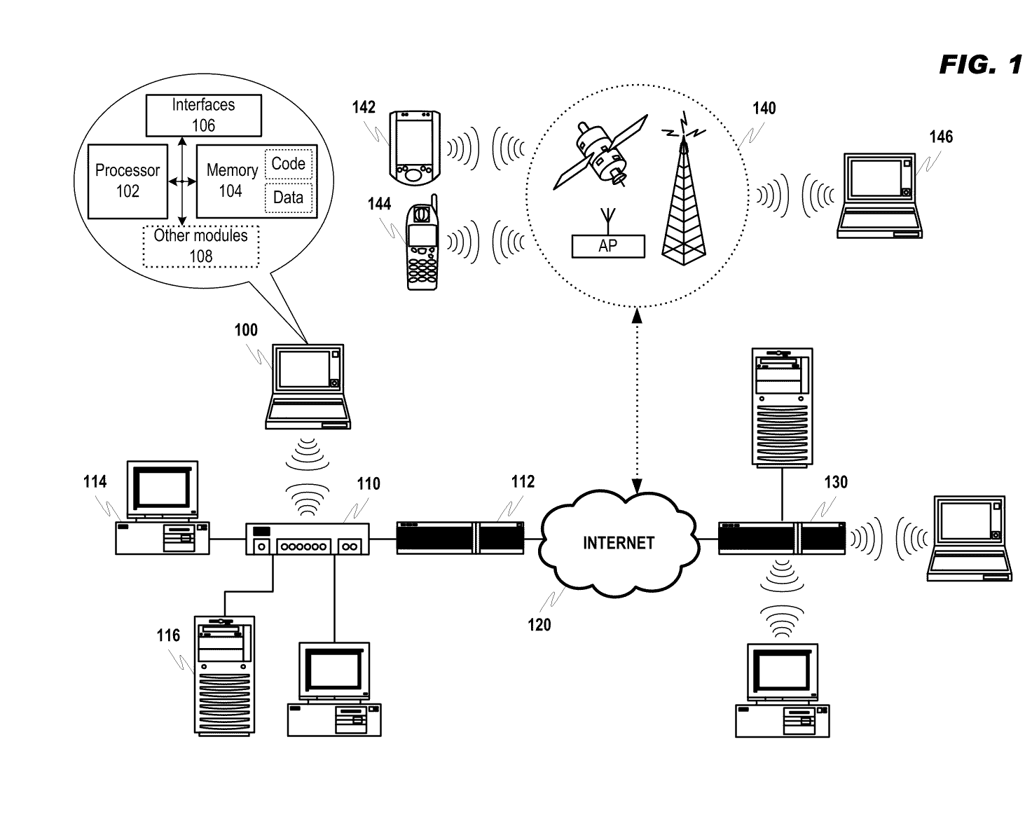

An example of a system that is usable for implementing various embodiments of the present invention is disclosed in FIG. 1. The system comprises elements that may be included in, or omitted from, configurations depending, for example, on the requirements of a particular application, and therefore, is not intended to limit present invention in any manner.

Computing device 100 may be, for example, a laptop computer. Elements that represent basic example components comprising functional elements in computing device 100 are disclosed at 102-108. Processor 102 may include one or more devices configured to execute instructions. In at least one scenario, the execution of program code (e.g., groups of computer-executable instructions stored in a memory) by processor 102 may cause computing device 100 to perform processes including, for example, method steps that may result in data, events or other output activities. Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 110 may provide wired and/or wireless support to devices such as computer 114 and server 116. Hub 110 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

### II. Example Operational Scenario

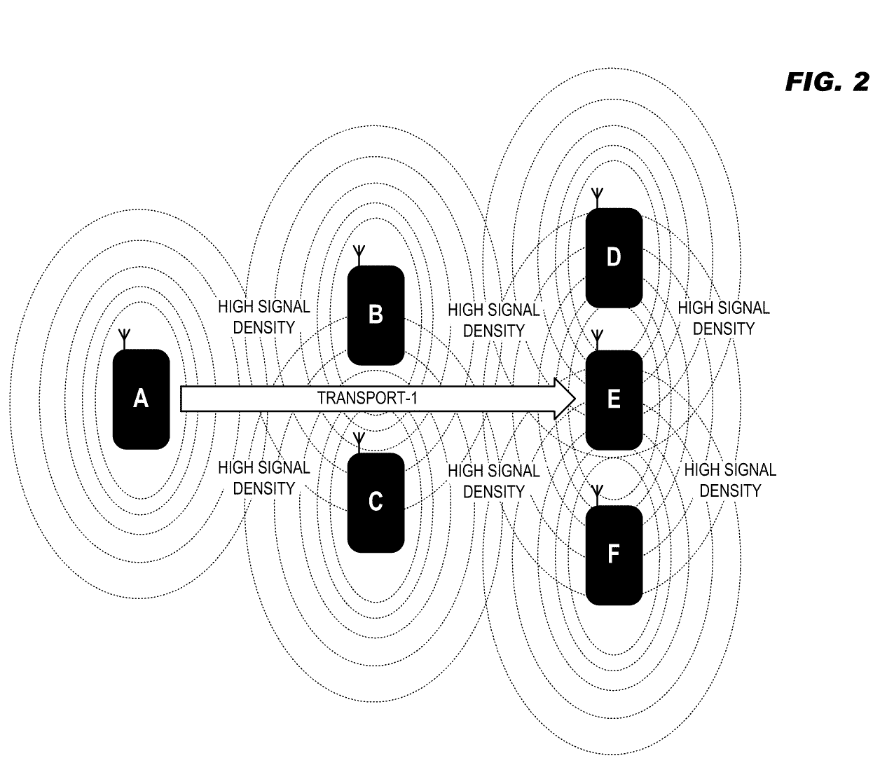

Now referring to FIG. 2, an example operational scenario to which the various example embodiments of the present invention may be applied is disclosed. Apparatuses “A” through “F” are capable of interacting via wireless communication. While apparatuses A-F are all wireless-enabled, the particular configuration of these apparatuses does not necessarily need to be identical. Only the ability to communicate using at least one common wireless transport (e.g., transport-1 as disclosed in FIG. 2) would be required in this instance.

In this instance apparatus A has data waiting to be conveyed to at least one other device. Apparatus A may convey this information by initiating omnidirectional transmission to other proximate apparatuses. In view of their relative location with respect to apparatus A, apparatuses B and C will receive the transmission first and may subsequently retransmit the message using omnidirectional communication. Retransmission may be necessary for various reasons in the example scenario of FIG. 2 including that the identity of the intended recipient device is not apparent, apparatuses D-F may be out of range of apparatus A, etc. Similar rationale may also exist that causes retransmission of the data from apparatuses D-F as well.

A substantial amount of signal activity may be created in the interaction scenario disclosed in FIG. 2. Not only will data be omnidirectionally transmitted from the original source (e.g., apparatus A), but omnidirectional transmission will subsequently occur in each of the other proximate apparatuses B-F. FIG. 2 graphically depicts example areas where there will be high signal density, which may cause interference between the apparatuses and a reduction in the overall quality of service. The impact of high signal density may be worsened by other nearby interference sources, and while not pictured, the high signal density created by apparatuses A-F may also create interference for other wireless communication occurring in range of apparatuses A-F.

### III. Examples of Directional Wireless Communication

The situation proposed in FIG. 2 may be improved through the implementation of directional wireless communication. For example, “Beamforming” techniques for adjusting multi-element antenna systems in transmission and/or reception side apparatuses may be utilized to both focus transmission/reception signals in order to improve quality of service, as well as to reduce extraneous signal noise that may be created by wireless transmission. In many channel environments, a lack of significant scattering or richness in multipath operation may reduce the applicability of traditional multiple input-multiple output (MIMO) spatial multiplexing schemes in an effort to increase spectral efficiency. As a result, simple beamforming techniques with the objective of transmitting and receiving towards the best beam-direction in order to maximize the signal-to-noise ratio (SNR) for single spatial data stream are required. To extend the range of coverage, these antenna systems may be equipped with beam steering capability to focus upon the best direction for transmission and/or reception. Antenna systems may further consist of multiple sectored antennas with sector switching capability over a desired sector direction.

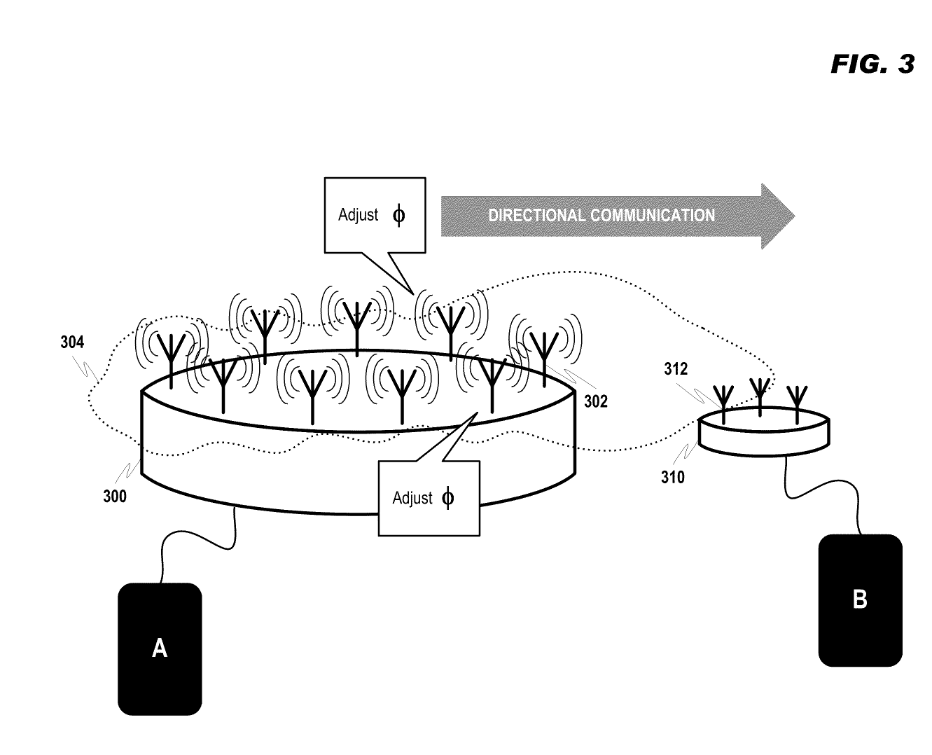

FIG. 3 discloses an example comprising two apparatuses that will be utilized herein to explain various example implementations of the present invention. While two example apparatuses A and B are shown in FIG. 3, the various embodiments of the present invention are not specifically limited to this configuration, and may be applied in scenarios involving more devices. For example, one of the apparatuses may take the role of a control point in a private basic service set. Furthermore, situations may also exist where one of the apparatuses takes the role of the control point only temporarily, for example, in an ad-hoc networking environment where the roles of the apparatuses are constantly changing. Apparatuses A and B are further shown coupled to external antenna systems 300 and 310, respectively. While these antenna systems have been shown as entities separate from each apparatus, this representation has been used merely to facilitate the disclosure of the various embodiments of the present invention. Antenna systems may also be implemented in a more compact configuration (for example, as part of a integrated circuit or chipset) that may incorporated within each apparatus.

Antenna systems 300 and 310 may include a plurality of antennas (for example, shown at 302 and 312) that may in some instances comprise, for example, a switched set of directional fixed-beam antennas. The number of antennas in an antenna system may depend on apparatus characteristics. For example, restrictions on apparatus size, power, processing, etc. may dictate the number of antennas implemented in an antenna system. Some or all of antennas 302 and 312 in antenna systems 300 and 310 may be active at any given time. Directional wireless transmission may achieved by adjusting the signals emitted by the antennas to create constructive interference. For example, the phases (Φ) of feed input signals to one or more antenna elements may be controlled using predefined weight vectors in the transmitter and/or receiver. Phase controls may adjust gain vectors to maximize antenna gain towards the desired direction of transmission and/or reception. The resulting constructive interference may create waveform 304 having the combined amplitude of the original waves oriented in a particular direction (e.g., in a directional transmission beam). In apparatuses utilizing a multiple sector antenna configuration, beamforming may be performed simply by switching to the antenna sector that is in the direction determined to be best during a beamforming training operation.

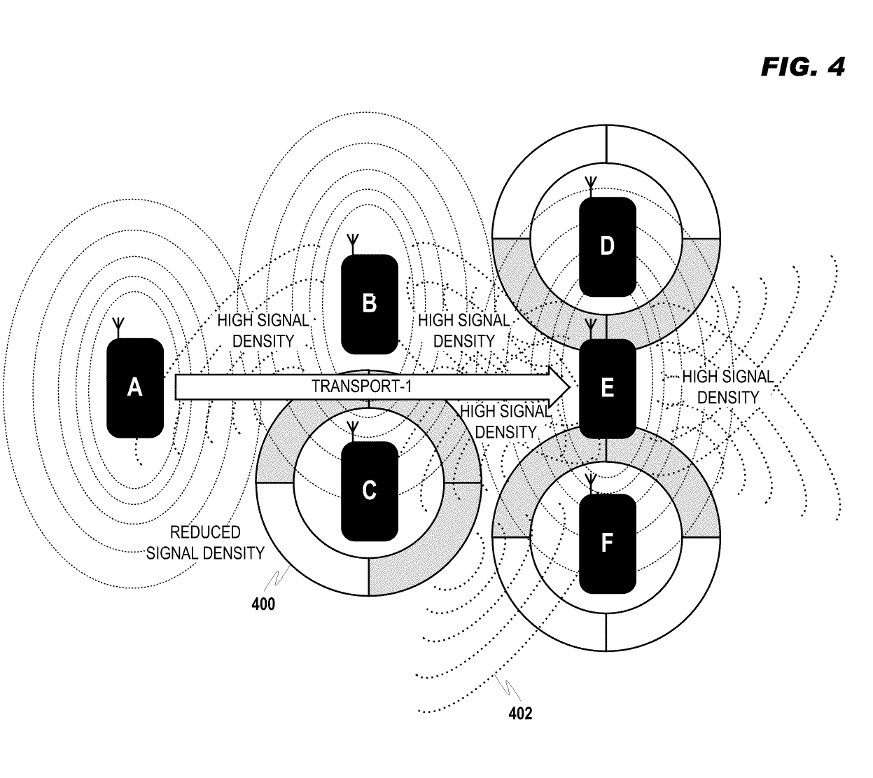

FIG. 4 revisits the example scenario of FIG. 2, but now, in accordance with at least one embodiment of the present invention, the ability for at least some of the apparatuses to communicate using directional wireless transmission is introduced. More specifically, apparatuses C, D and F are represented as being capable of directional wireless communication utilizing transport 1. Directional wireless communication is shown through the use of sector maps 400. Sectors define the directions in which an apparatus may transmit a communication beam. All of apparatuses C, D and F have four sectors in sector map 400, which may mean that in this particular situation these devices can transmit communication beams (shown for example at 402) in one or more of the radial directions corresponding to the sectors. While each apparatus is disclosed as having four sectors, the various example embodiments if the present invention are not limited as such. Subdividing sector map 400 into smaller sectors, and hence increasing the number of sectors, may result in improved resolution for wireless directional communication, possibly yielding better quality and less interference.

Similar to FIG. 2, apparatus A in FIG. 4 may have data pending transmission to other proximately-located apparatuses (e.g., apparatuses B-F). An omnidirectional data signal transmitted from apparatus A may initially be received by apparatuses B and C. Apparatus B may repeat the data transmission omnidirectionally as previously described, however, apparatus C is capable of directional communication. As directional communication would presuppose that a preferred direction of transmission exists, apparatus C may be aware of other proximally-located apparatuses to which transmission is desired. For example, apparatus C may be “aware” of apparatuses B and D-F, which may not have received the data transmitted from apparatus A. This is represented in FIG. 4 by three sectors of sector map 400 being highlighted. Apparatus C may then transmit directional beams 402 over these sectors in order to ensure that the data is passed to apparatuses B and D-F. No directional beam is sent in the direction corresponding to the remaining sector of sector map 400 as only apparatus A, the original data provider, would fall in this sector. Apparatus E may retransmit the data omnidirectionally since directional wireless transmission is not supported, while apparatuses D and F may limit transmission to sectors where apparatuses that may not have received the data are known to, or at least presumed to, reside.

It is evident from the example scenario disclosed in FIG. 4 that the overall signal density of the operating environment may be affected by the introduction of directional wireless communication. For instance, as apparatus C acknowledged the fact that at least one sector of sector map 400 only contained the originating device (apparatus A), no directional beam was sent in the direction corresponding to this sector. This determination by apparatus C resulted in reduced signal density in the region falling between apparatuses A and C. Moreover, a similar reduction in signal concentration may occur surrounding apparatuses D and F as the data is only transmitted in the directions corresponding to the two highlighted sectors of their sector maps.

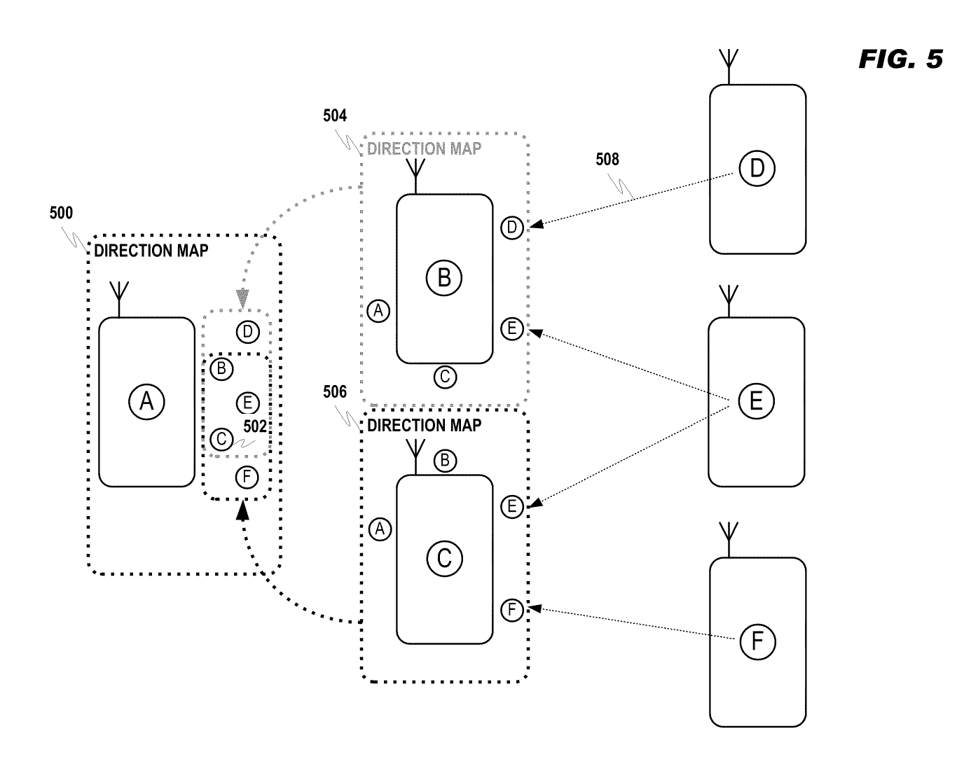

In accordance with various embodiments of the present invention, an example of how an apparatus might be “aware” of other apparatuses is disclosed in FIG. 5. Some or all of the apparatuses A-F may comprise direction maps, shown for example at 500, 504 and 506 corresponding to apparatuses A-C, respectively. Direction maps may define the location of other apparatuses. Location can be derived using a variety of methods including, but not limited to, defining a relative direction and/or position of other apparatuses with respect to the apparatus to which the map corresponds, defining the location and/or direction of an apparatus based on a fixed reference such as latitude and longitude, global positioning system (GPS) coordinates, compass bearings in degrees or polar coordinates, etc.

Direction map 500 corresponds to apparatus A, and may therefore be stored within the memory of apparatus A. Map information may be kept accurate in accordance with various information updating strategies such as periodic updates, updates on apparatus location change, etc. Representations 502 of each apparatus A-F are shown relative to the position of apparatus A in example direction map 500. As described above, the positional relationship of these apparatuses may be defined based on the position of each apparatus with respect to apparatus (in view of a fixed or relative coordinate system), or alternatively, may simply be defined as a direction towards each apparatus from the apparatus with the direction map. In at least one example configuration, the direction towards an apparatus may be generally recorded as the apparatus direction falling within a particular sector in the sector map of the reference apparatus (e.g., the transmitting apparatus). In various example embodiments of the present invention direction maps may also include other information, such as estimated distances, etc.

In accordance with the example embodiment of the present invention that is disclosed in FIG. 5, direction map 500 defines the location of apparatuses B-F with respect to apparatus A, while direction map 504 defines the location of apparatuses A, C, D and E with respect to apparatus B and direction map 506 maps the location of apparatuses A, B, E and F with respect to apparatus C. The information utilized in building each direction map may be obtained directly by sensing a location and/or position for an apparatus (e.g., by beamtraining such as shown at 508). However, situations may occur where the particular wireless transport being utilized for directional communication may not have range to sense all apparatuses. For example, transport-1 (as shown, for example, in FIG. 4) may not have the range to allow apparatus A and apparatus D to interact directly, even with the enhanced range that may be provided through use of directional wireless communication. In such instances, direction maps may be created in apparatuses by incorporating direction map information from other nearby devices. For example, FIG. 5 shows apparatus B obtaining a relative position and/or direction for apparatus D and E via sensing at 508. However, in accordance with at least one example embodiment of the present invention, the relative positions/directions of apparatuses B-F with respect to apparatus A in direction map 500 may be created by incorporating some or all (e.g., excluding overlaps) of the information from direction maps 504 and 506 into direction map 500.

### IV. Example Implementations Including Transport Selection

Example scenarios using omnidirectional communication and directional wireless communication have been disclosed above. However, in accordance with at least one example embodiment of the present invention, these configurations may be enhanced by the incorporation of transport selection functionality. The orchestration of transport selection in situations such as previously described is made problematic in that traditionally the transport used by all devices is established by the initial transmission (e.g., apparatus A), which does not provide any flexibility.

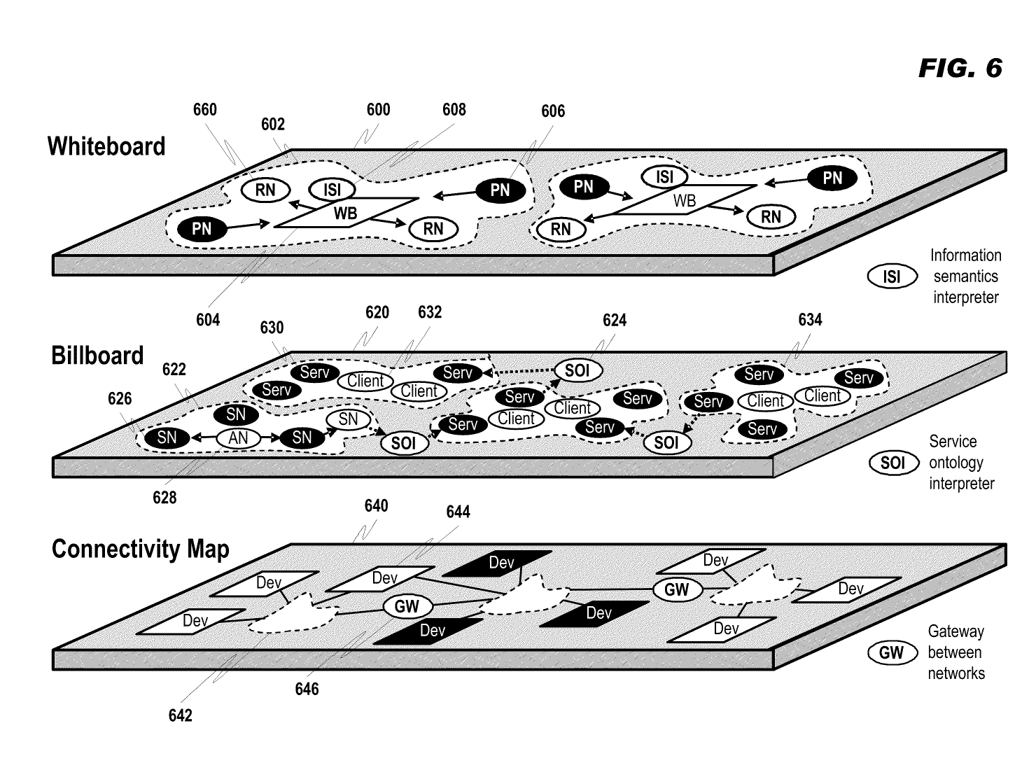

Instead, various implementations of the present invention may employ an architecture that allows for flexible transport selection on an apparatus-by-apparatus basis, while providing transparency to higher level entities (e.g., software applications). An example of such a wireless communication architecture is a Network on Terminal Architecture (NoTA), which is generally discussed in connection with FIG. 6. Whiteboard 600 may comprise the highest level of operation in this architecture. At this level, operational groups 602 may be formed including whiteboards 604 and various application nodes. Application nodes may correspond to applications existing on a plurality of wireless communication devices, and may be utilized to exchange information between these applications, for example, by placing data into, and removing data from, whiteboard 604. For example, various node types may comprise proactive nodes (PN) 606 that may place information into whiteboard 604, reactive nodes (RN) 610 may be tasked with taking information from whiteboard 604. Information semantics interpreter (ISI) 608 may further be utilized to link different whiteboards together. Utilizing these constructs, Whiteboard 604 may provide for application interaction that overcomes many incompatibilities.

Billboard level 620 may facilitate interaction between services available on the one or more devices. For instance, Billboard level 620 may enable the sharing of service-related information (e.g., service identification information, functionality, etc.), as well as information that may be necessary in order to access and/or utilize each service. Services 630 and clients 620, which may utilize these services, may be organized in service domains 622. In at least one scenario, service domains 622 may correspond to a particular protocol, such as Universal Plug and Play (UPnP), Bluetooth Service Discovery Protocol (BT SDP), Bonjour, etc. In each service domain 622, services 630 may be represented by service nodes (SN) 626, and likewise, application nodes (AN) 628 may be established to correspond to applications. Further, service domains 622 may interact utilizing service ontology interpreters (SOI) 624. SOI 624 may allow various service domains 622 to interact, even if the service domains 622 reside on different wirelessly-linked devices (e.g., to provide access information between service domains 622).

Connectivity map 640 may define available connectivity methods/possibilities and topology for apparatuses participating in sharing resources in order to support whiteboard 600 and billboard 620. In accordance with at least one embodiment of the present invention, devices 644 may be linked in directly connected groups 642. Examples of directly connected groups of devices (Dev) 642 may include devices connected via Bluetooth piconets, Wireless local area networks (WLAN), wireless Universal Serial Bus (WUSB) links, etc. Each directly connected group 642 may further be linked by gateways (GW) 646.

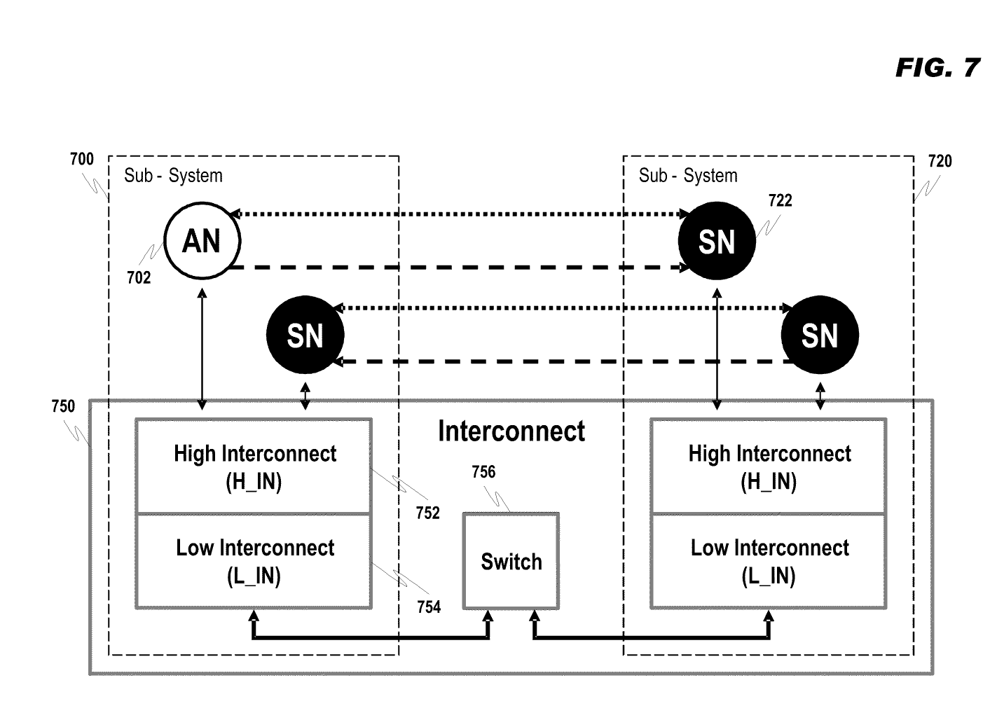

In accordance with at least one embodiment of the present invention, FIG. 7 discloses an example of an underlying logical architecture that may be utilized in implementing NoTA. NoTA may be configured as multiple subsystems (e.g., 700 and 720) coupled by interconnect 750. NoTA interconnect 750 may comprise High Interconnect (H_IN) layer 752 and Low Interconnect (L_IN) layer 754 coupled by switch 756. Low interconnect layer 754 may include ISO/OSI layers L1-L4 and may provide transport socket type interface upwards. High Interconnect layer 452 may act as the middleware between L_IN 454 and the higher level Application nodes (AN) 402 and Service nodes (SN) 422 residing in subsystems like 400 and 420. Key H_IN 452 functionality is to provide client nodes (AN 402 or SN 422) on top a direct access to services (without having to disclose the location of the latter). Communication may be connection-oriented, meaning that connection setup procedures need to be carried out before any service or data activity takes place. Security features can been added to counter identified threats. NoTA is an architecture that can provide intra-device service access, making it possible to build independent subsystems providing services and applications. NoTA implementations may comprise several apparatuses involved in inter sub-system communication.

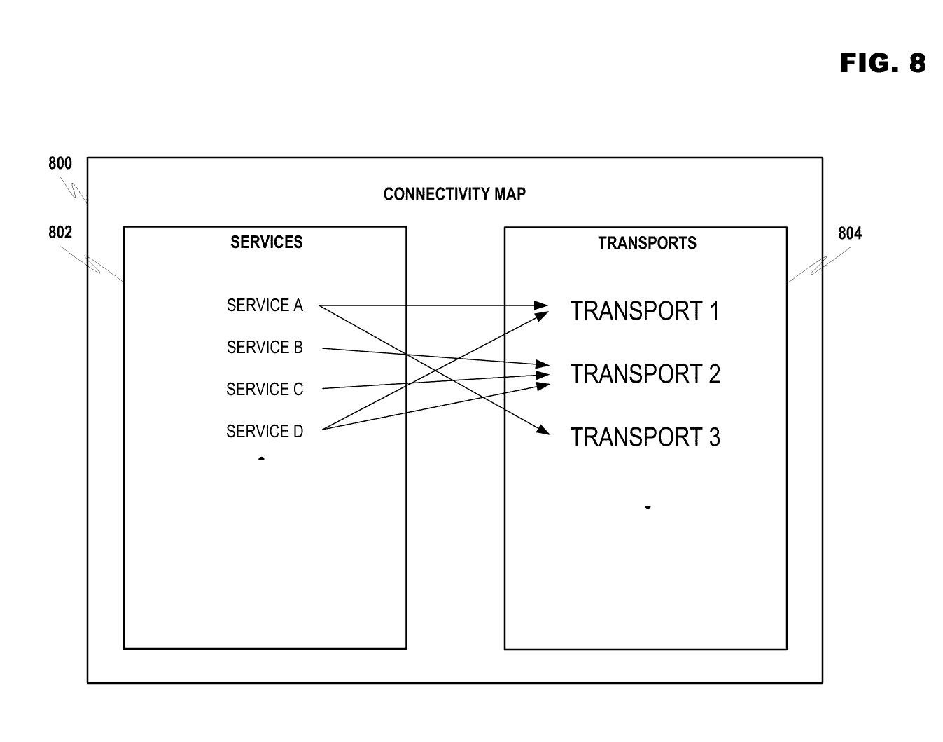

FIG. 8 discloses another underlying construct that may be implemented in at least one embodiment of the present invention. Connectivity map 800 may be utilized to map various services offered on the one or more devices participating in billboard table 300 to transports that can be utilized with each service. Transports may comprise, for example, Bluetooth, Bluetooth Low Energy (Bluetooth LE), WLAN, WUSB, etc. Services can be mapped for use with multiple protocols (e.g., Bluetooth and WLAN may be mapped to a service a preference for Bluetooth). However, the present invention is not specifically limited to using these particular wireless transports, and may be implemented with other wireless communication protocols that are usable by services offered by various devices. In this example, services offered by the devices may be listed under services 802, and the corresponding available transport mediums are listed under transports 804. Arrows between services 802 and transport mediums 804 indicate the one or more transport mediums usable by each service. The information in connectivity map 800 may, in accordance with various embodiments of the present invention, create a binding between billboard table content (e.g., service offerings) and connectivity map table content (e.g., available device connectivity configurations) so that this information may be utilized in determining transports that are usable with a particular service. Where two or more transports are available, a particular transport may be selected based on criteria such as speed, activity priority, predefined preferences, apparatus condition, other active wireless transports or sensed interference, etc.

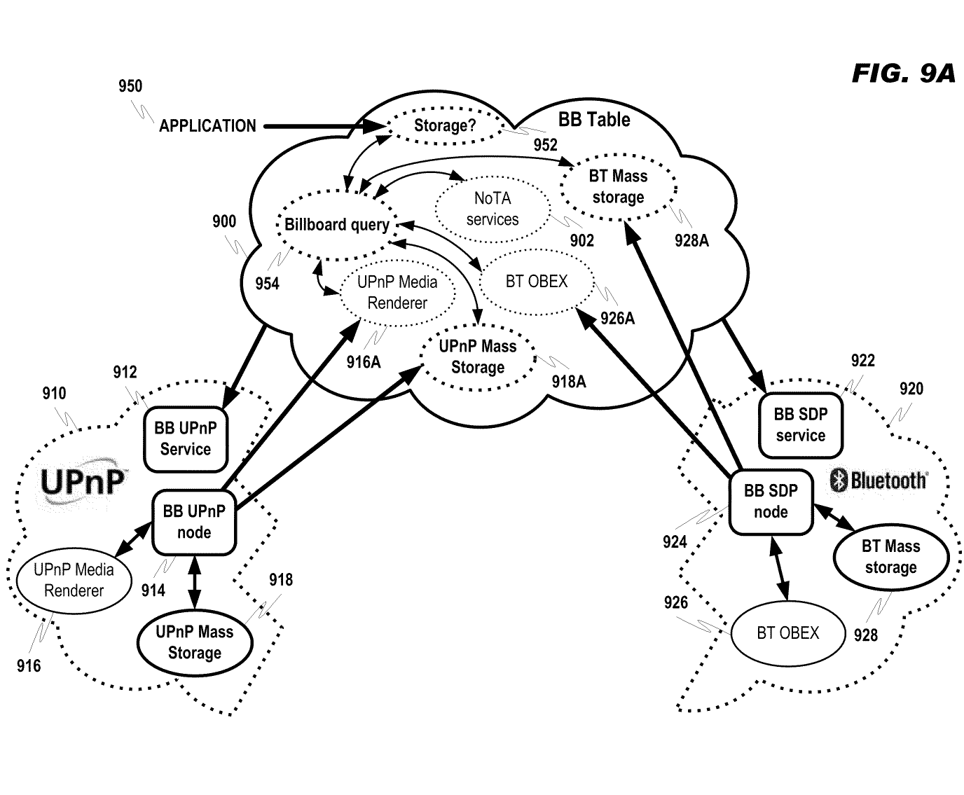

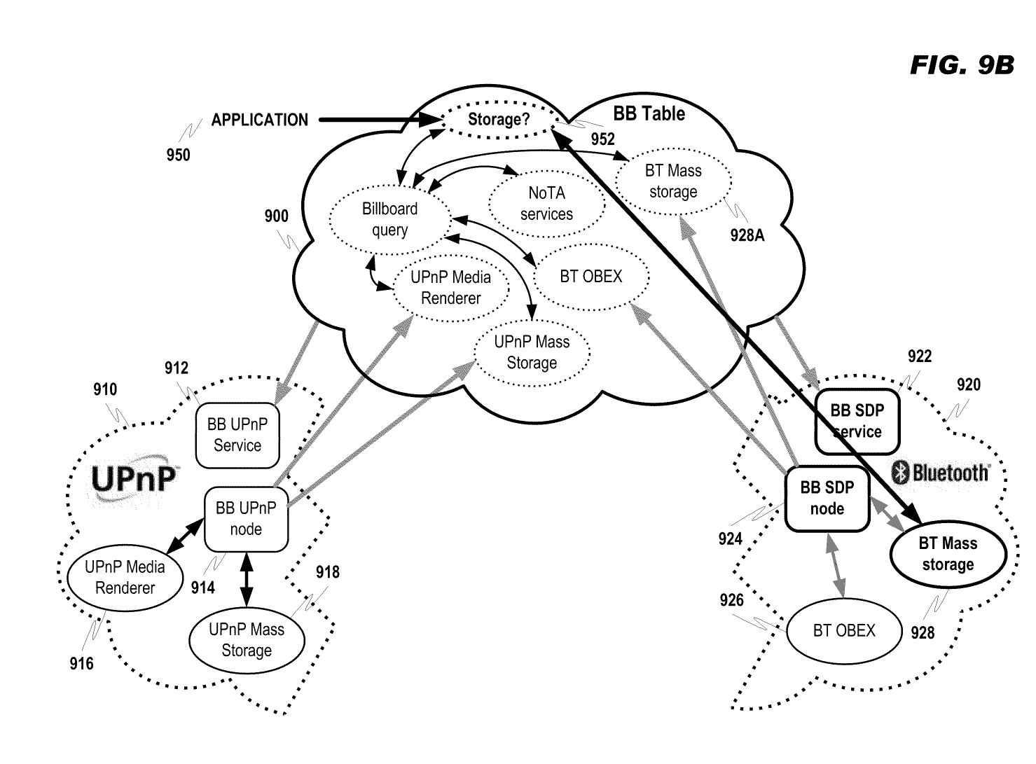

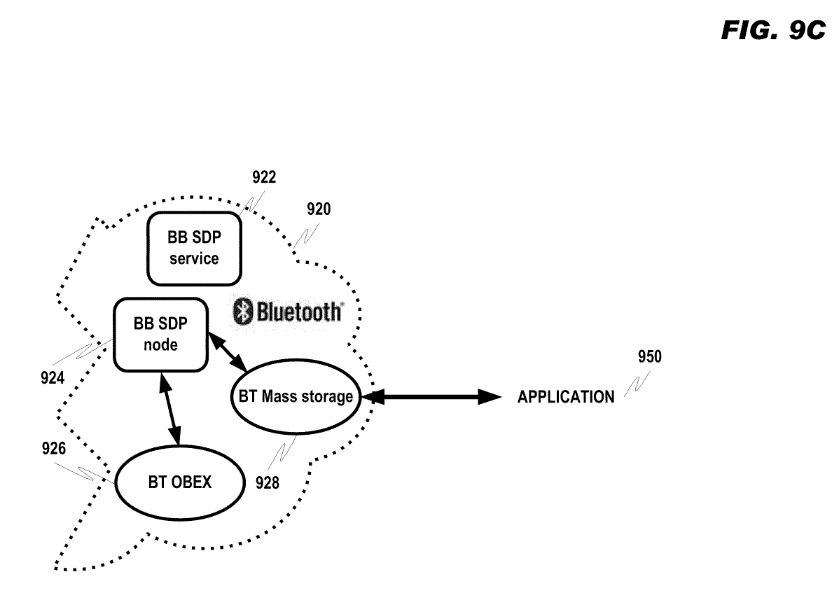

Services may be defined as functionality that is offered or derived from software programs. Services may related to various apparatus functionality, and may be provided, for example, by an operating system or may be added to an apparatus by accessory applications related to communication, security, productivity, device resource management, entertainment, etc. FIG. 9A discloses an example of billboard functionality in accordance with at least one embodiment of the present invention. Billboard 900 may comprise a shared memory space established amongst one or more wired or wireless apparatuses. The scenario disclosed in FIG. 9A may further include a protocol such as UPnP 910 and Bluetooth SDP 920 installed, for example, on a separate apparatus. Billboard 900 may interact with these protocols using one or more services, such as example billboard services BB UPnP service 912 and BB SDP service 922. BB services 912 and 922 may typically be components of UPnP and BT architecture, but can also be components of a NoTA architecture. UPnP 910 may offer services locally on the apparatus in which it resides, such as UPnP media renderer service 916 and UPnP mass storage service 918. Similarly, Bluetooth SDP 920 may provide BT OBEX service 916 and BT mass storage service 928 on another device. It is important to note that these services have been used only for the sake of example in the present disclosure, and are not intended to limit the services usable with example embodiments of the present invention.

Service information entries corresponding to services offered on each apparatus may be created in billboard table 300. For example, BB UPnP node 914 and BB SDP node 924 may create service information entries UPnP media renderer service 916A and UPnP mass storage service 918A, as well as BT OBEX service 926A and BT mass storage service 928A, respectively. These service information entries exist in a common billboard table 300, despite the protocols and services actually residing on separate devices. Service information entries may provide information about services to other services and/or applications, such as the name of the service, service properties, pairing & authentication information utilized in accessing a particular service and/or transports usable with each service. Service information may be obtained, for example, via BB SDP service 924 if billboard table 900 is to be accessed from the BT domain, or BB UPnP service 914 if billboard table 900 is to be accessed from the UPnP domain. Some architectures, such as NoTA, may support billboard services directly. NoTA services 902 may be utilized, in accordance with at least one embodiment of the present invention, to establish a shared memory space, residing on multiple apparatuses, wherein Billboard table 300 may reside.

FIG. 9B-9C further disclose an example use situation in accordance with at least one embodiment of the present invention. Application 950 running on one of the devices participating in billboard table 900 may have a requirement for storage as indicated at 952, which be fulfilled by services that can provide storage activities residing on at least one of the apparatuses participating in the shared memory space. This inquiry may be performed, at least in part, by a billboard query 954 using information in storage inquiry 952. All of the service nodes in billboard table 900 may be queried in order to determine any services that can fulfill the needs of application 950. In FIG. 9A two service nodes have been highlighted as potentially corresponding to services appropriate for storage requirement 952: UPnP mass storage 918A and BT mass storage 928A. Billboard query 954 may further obtain information related to the services from their respective nodes. For example, property information may be supplied by service information entries 918A and 928A to application 600 via billboard query 954. Information regarding transport mediums usable by each service may also be obtained through the use of connectivity map 800. The property information may be used in determining which service to select. For example, the properties of a particular service may be more useful for, or accessible to, application 600. A particular service may also be selected because a usable transport is better able to support the activity to be performed because other transports already have too much traffic, are experiencing interference, conflict with other transports, etc.

In FIG. 9B, BT mass storage service information entry 928A has been selected to support the storage requirement 952 defined for application 950. This selection may be made automatically by control elements existing in the participating apparatuses, by application 950, by user selection of a preferred service and/or transport, etc. Billboard query 954 may then obtain information for accessing BT Mass storage service 928 from BT mass storage service information entry 928A. Such information may comprise property information and transport information that may be conveyed to application 950 in order to facilitate a direct link between application 950 with BT Mass storage service 928, an of which is disclosed in FIG. 9C.

The example described in FIG. 9A-9C describes a situation where a resource consumer (e.g., application 950) is connected to a resource provider (e.g. BT Mass storage service 928) in accordance with various embodiments of the present invention. However, it is important to realize that the actual wired or wireless transport that is used to establish the connection between these entities may be transparent to both resource consumer and provider. More specifically, the specific transport selected is not visible to the application and service. The application and service may simply utilize the connection that the NoTA system selects. This type of functionality may provide other benefits. Potential traffic and interference experienced when utilizing the same wireless transport for multiple connections (e.g., between multiple apparatuses) may not necessarily be remedied by switching to another wireless transport. Other wireless transports may be active within the same frequency band, resulting in problems that are similar to maintaining multiple links using the same wireless transport. Moreover, environmental factors such as electromagnetic field interference (EMI) may interfere with wireless transports operating in the same frequency range. The impact of such problems may be exacerbated when many apparatuses are interacting in a common area. The environment for apparatuses located in one physical area may be totally different from apparatuses in other areas, and thus, the communication considerations for each may be different.

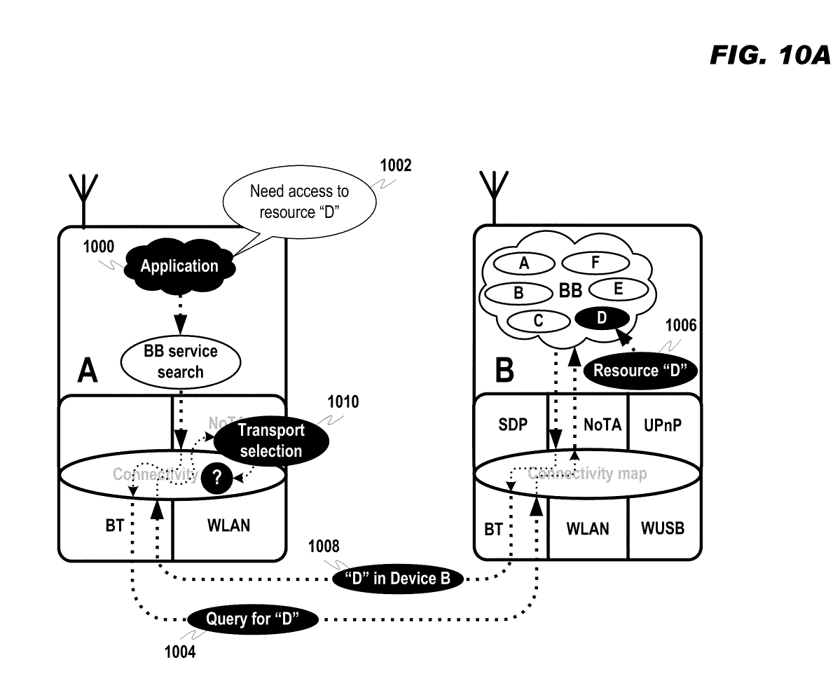

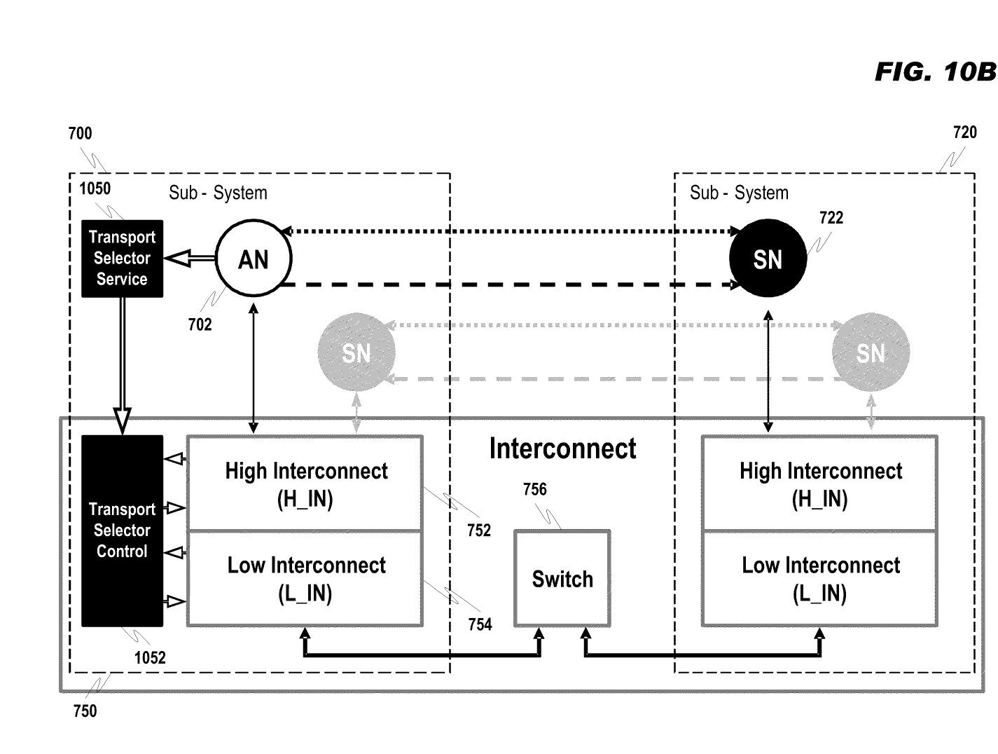

In accordance with at least one embodiment of the present invention, FIG. 10A discloses an example of system that may be utilized to coordinate transport selection for some or all apparatuses interacting via a shared memory space. For example, communication activity between apparatuses may be regulated by making communication configuration information available to the apparatuses via entities (e.g., services) residing in the shared memory space.

In accordance with at least one example embodiment of the present invention, FIG. 10A discloses a possible interaction between apparatuses A and B. Interaction between only two apparatuses has been disclosed in FIG. 10A for the sake of explanation herein, and thus, the present invention is not limited to use with only two apparatuses. Interaction in this scenario may be initiated by any participating apparatus, but in the disclosed example is triggered by application 1000 in apparatus A. Application 1000 may be, for example, a software or program module that, upon activation, execution or user interaction, creates requirements to access a resource (e.g., as shown at 1002). In accordance with the previously disclosed example embodiments of the present invention, BB search 954 may utilize an initial transport, such as Bluetooth (BT), to perform queries 1004 of available resources in the NoTA environment. The same transport may also be used for exchanging connectivity map information, which may eventually be utilized in transport selection 1010 when appropriate transports are to be selected. The accumulation of this available resource information may help facilitate the identification of potential providers in the NoTA system for requested resources, such as resource “D” requested by application 1000. For example, information in BB 900 may disclose that resource “D” 1006 actually resides on apparatus B which is also participating in the NoTA environment, and thus, apparatus B is able to act as a “provider” for resource “D” to application 1000 on apparatus A.

A response 1008 to inquiry 1004 may identify one or more potential resources (e.g., services, databases, etc.) residing on at least one provider (e.g., apparatus B). However, limiting subsequent transactions to use of the transport that was initially selected in order to perform the query may substantially impact quality of service. For example, low power, low throughput transports like Bluetooth Low Energy (Bluetooth LE) may be adequate, and in some instances preferred, for performing initial queries. Nevertheless, the same type of transport would not be likewise appropriate for subsequent communication if large amounts of data are to be conveyed, a low amount of errors is required or other similar requirement exist. Therefore, transport selection service 1010 may be implemented in order to select one or more transports based, for example, on the requirements of application 1000. The selection of one or more transports may be transparent at the consumer (e.g., application 1000) and provider (e.g., resource “D” 1006) level. Therefore, if multiple transports would be usable in establishing a connection to a required resource, the aforementioned requirements may be considered, possibly along with other criteria such as apparatus condition (e.g., wireless activity, power level, etc.) and environmental condition (e.g., sensed communication or interference activity) when narrowing down the potential transports to the most appropriate for use in subsequent activity.

FIG. 10B discloses an example of the integration of transport selection service 1010 into an NoTA in accordance with at least one example embodiment of the present invention. Transport selection service 1010 may comprise a transport selection node element 1050, which may correspond to transport selection services that are provided by system-level element 1052. Transport selection node 1050 may be utilized to provide configuration information between devices, such as between two transport selection nodes existing on different devices. Generally, transport selection node 1050 may exchange configuration information and transport selection service element 1052 may provide access rules corresponding to certain transport techniques. Application level entities may, for example, provide detailed requirements (e.g., speed, minimum QoS, security, etc.) for certain connections directly to transport selection node 1050, or alternatively, through direct interaction with transport selection system-level element 1052.

As set forth above, it is possible for activities performed by transport selection service 1010 to be transparent to upper-level entities. In this way, applications may simply specify the type of connection needed and may then rely on lower level control resources to establish a connection having the required characteristics. An example of such transparency is disclosed in FIG. 10B. AN 702 may interact with transport selection node 1050, or alternatively, may interact directly with H_IN 752. Part of this interaction may include the specification of required operational parameters for a requested connection. Transport selection node 1050, or alternatively L_IN 754, may then provide requirement information to, and receive configuration information from, transport selection system-level element 1052. Configuration information may comprise, for example, one or more preferred connection configurations. Regardless of how requirement information reach transport selection system-level element 1052, transport selection node 1050 may still exist to convey configuration information between devices.

In the example implementation disclosed above, transport selection system-level element 1052 may provide access to various types of information such as one or more preferred communication configurations (e.g., selected transports, modes of operation, etc.) or information that may be usable by apparatuses when formulating their own communication configuration. Alternatively, transport selection system-level element 1052 may represent that the required access is not currently possible/permitted based on the accumulated configuration information.

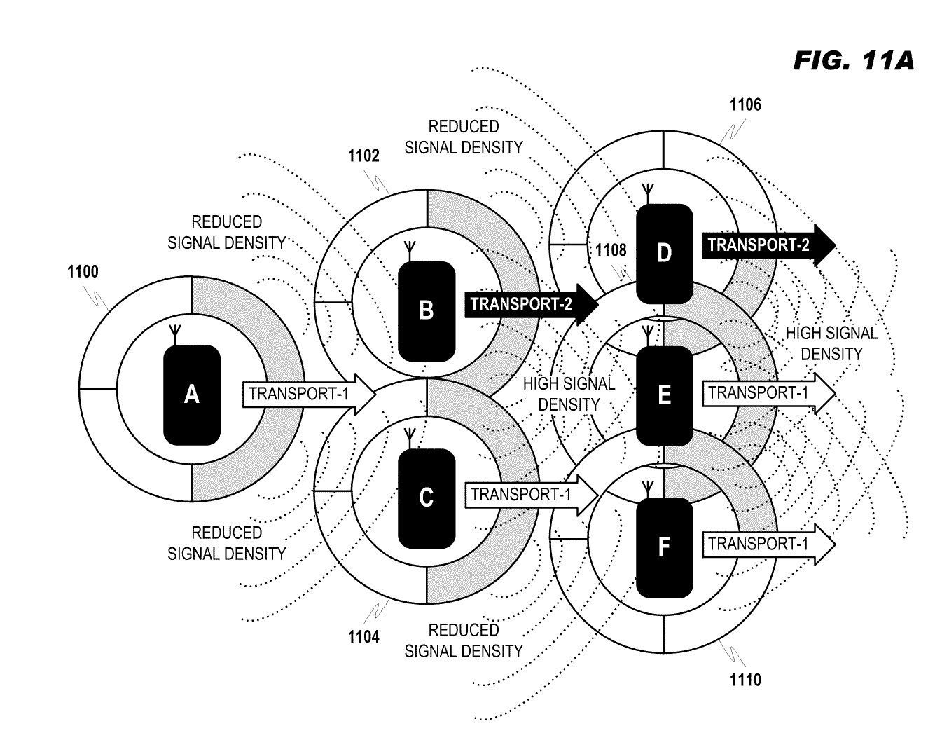

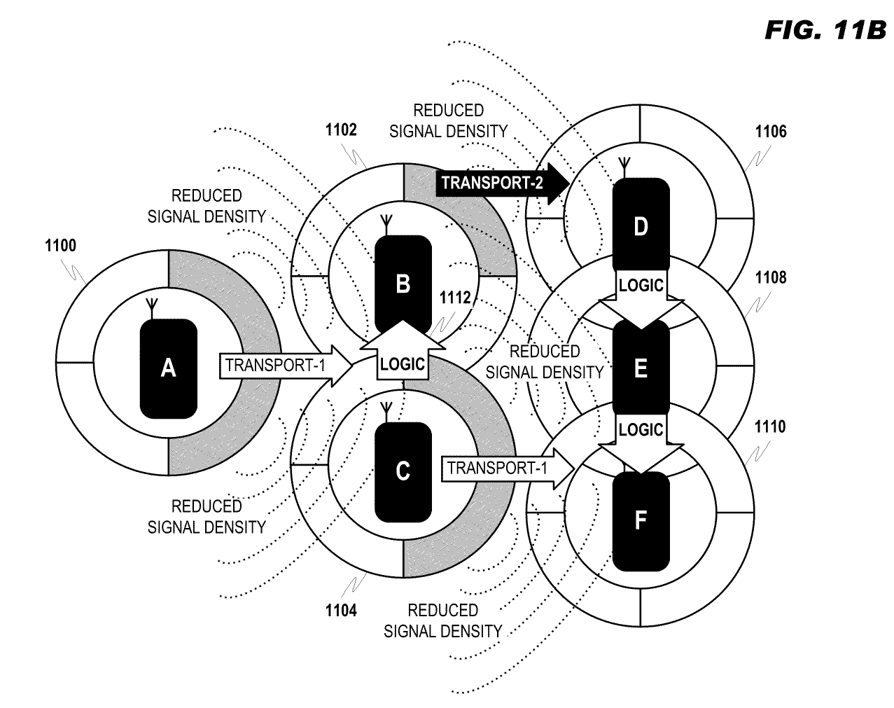

FIG. 11A applies both directional wireless communication, in accordance with the example embodiment of the present invention disclosed in connection with FIG. 4, and the above example transport selection to the scenario originally set forth in connection with FIG. 2. The example disclosed in FIG. 11A assumes that all apparatuses A-F have the ability to perform directional communication using at least one wireless transport, however, this particular scenario is not required in order to implement the various embodiments of the present invention, and has only been utilized for the sake of explanation herein. Apparatus A again has data to transmit. In this instance however, all apparatuses may be aware of the other proximally located apparatuses (e.g., based on direction maps as disclosed in FIG. 5). Apparatus A may then utilize transport-1 to transmit communication beams over the sectors in sector map 1100 that include apparatuses B and C. More specifically, apparatus A may select both direction and wireless transport based on, for example, the example criteria described above. Apparatuses B and C may make similar decisions regarding direction and transport. Initially, apparatus B selects a different wireless transport (transport-2) than utilized by apparatus A. There are many rationales for selecting a different transport, such as the lack of support for directional wireless communication using transport-1, in order to avoid possible interference issues caused by other apparatuses utilizing transport-1, etc. Apparatus B then transmits the data over the sectors in the sector map 1102 corresponding to the perceived locations of apparatuses D and E. Apparatus C may go through a similar process, but arrives at a different result (e.g., different sectors selected for transmission in sector map 1104 or a different transport). This may occur, for example, due to functionality, configuration or conditional differences existing between apparatuses B and C.

In a similar manner apparatuses D-F may make decisions regarding transmission direction and transport. Taking into account the direction and/or the apparatuses from which the data was received, apparatuses D-F may limit their transmission to sectors wherein apparatuses that have not yet received the transmission data may reside. Since no further apparatuses exist in the example operational area except apparatuses A-F, apparatuses D-F only transmit the data to each other. This can be seen by the sectors selected for transmission in sector maps 1106-1110. It may be observed in FIG. 11A that a further reduction in signal density occurs due to the introduction of both direction and transport selection control. However, further example embodiments of the present invention may achieve better density reduction by introducing logic.

Another example implementation in accordance with at least one embodiment of the present invention is now disclosed in FIG. 11B. This operational example adds the further logical consideration to direction and transport selection decisions. Transmissions received by apparatuses may be evaluated in view of certain criteria in order to further refine selection. For example, transmitted data may comprise an indication of the apparatus for which the data is intended. This information may initially be evaluated to determine if the indicated device is the current apparatus (e.g., apparatus B receives information intended for apparatus B). In such an instance no further transmission would be necessary, which would greatly reduce both the resources expended by apparatuses A-F and the signal noise created by multiple retransmissions. On the other hand, if the intended apparatus is not the apparatus that received the transmission, the receiving apparatus may utilize information provided, for example, in the form of a direction map residing in the apparatus, to select a direction and transport based on the intended recipient. Such activities may also reduce signal density depending on what is known about the recipient apparatus (e.g., if location and/or supported transport information is available for the recipient).

The addition of logic may also be beneficial when there is no intended recipient. In FIG. 11B apparatus A transmits data towards apparatuses B and C. Apparatus B may, based on criteria (e.g., logic 1112) such as the direction of arrival or the identity of the transmitting device, select only certain sectors in sector map 1102 for retransmitting the data. For instance, it may be assumed that when apparatus B receives a data transmission from apparatus A that apparatus C has also received the same transmission. Therefore, apparatus B need not retransmit the data to apparatus C. Logic may further dictate that apparatus C will retransmit the data to apparatuses E and F. As a result, apparatus B may only retransmit the data to apparatus D. A similar process may be employed between apparatuses D-F as shown by the occurrences of logic between apparatuses. For example, the receipt of a transmission in apparatus D from apparatus B may imply that no retransmission is required to apparatus E, and likewise, the receipt of the data from apparatus C in apparatuses E and F may prevent the retransmission of data. As a result, the signal density for the entire operational area may be significantly reduced. In addition, the ability to select a preferred wireless transport may reduce interference problems as at least one criteria that may be utilized for transport selection is the avoidance of potential collisions.

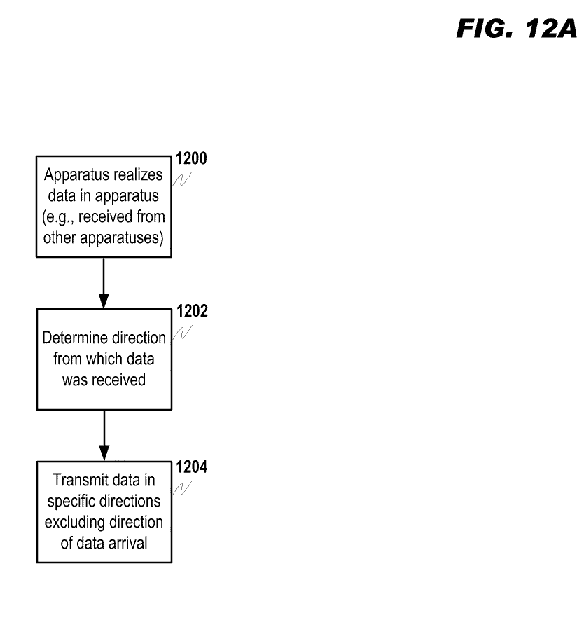

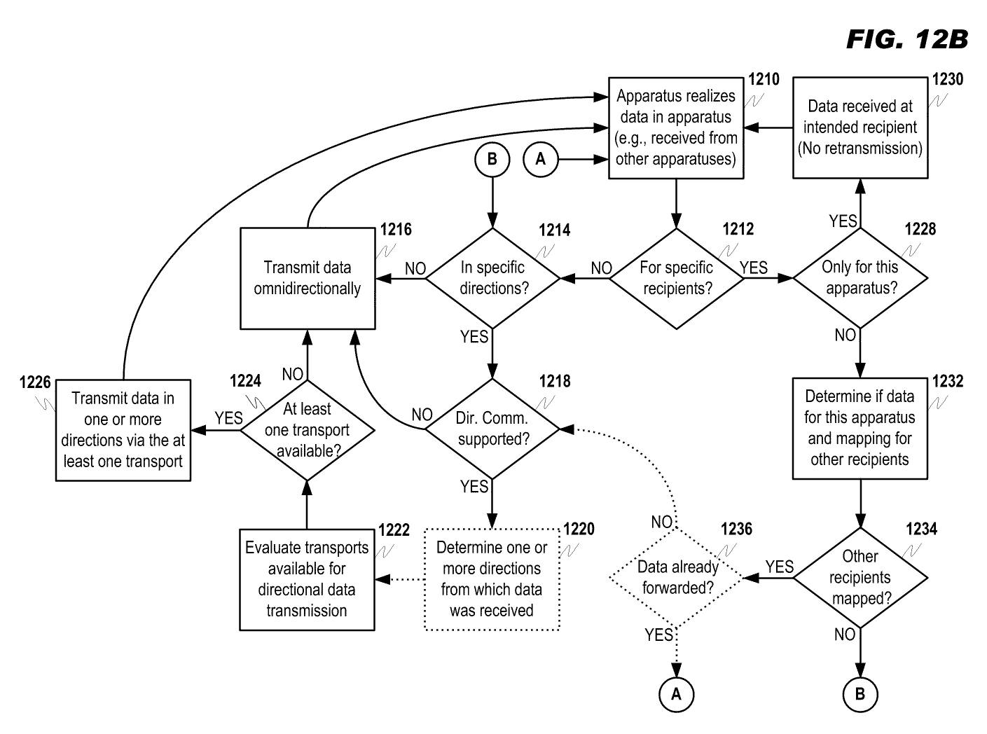

An example process for data distribution (e.g., data reception and retransmission) in accordance with at least one embodiment of the present invention is disclosed in FIG. 12A. Three steps are disclosed. In step 1200 data for transmission is identified (e.g., “realized”) in an apparatus. While it is presumed for the sake of explanation with respect to FIG. 12A that the data was received from outside the apparatus (e.g., via wireless communication from another apparatus), other scenarios may exist, for example, those discussed with respect to FIG. 12B.

In step 1202 the direction from which the data was received is identified. This process may utilize techniques such as Direction of Arrival (DoA) estimation to determine the direction from which a data carrier signal was received. The process may then move to step 1204 where the data is retransmitted. In accordance with at least one embodiment of the present invention, the data may be transmitted in one or more directions (e.g., “specific” directions) that exclude the one or more directions associated with the arrival of the data. The directions from which the data was received may be omitted because in certain instances the assumption may be that all of the apparatuses residing in the direction of data arrival have already received the data.

A more detailed flowchart of an example process usable in accordance with at least one example embodiment of the present invention is disclosed in FIG. 12B. In step 1210 an apparatus realizes data for transmission in the apparatus. This realization may be triggered by activities such as the creation of the data in the apparatus, a manual or automated triggering to transmit the data to a certain recipient, the receipt of the data in the apparatus, for example, via wireless transmission from another apparatus, etc. A determination may then be made in step 1212 as to whether there are specific recipients intended for the data. If no specific recipient is indicated (e.g., in terms of user identification, apparatus identification, etc.), then in step 1214 a determination may be made as to whether one or more transmission directions have been generally specified for the data. The one or more transmission directions may be specified within the data as, for example, a part of the data creation process (e.g., by the creating application). In another scenario, apparatuses may add information pertaining to the one or more directions before transmitting the data. If no directions are specified, then the data may be transmitted omnidirectionally in step 1216 and the process may then return to step 1210 to await the next realization of data in the apparatus.

If one or more transmission directions have been specified in step 1214, then a further determination may be made in step 1218 as to whether directional communication is supported in the apparatus. Directional communication may not supported due to, for example, limitations in the apparatus (e.g., limited apparatus functionality, size, power, etc.), no resources being available for directional transmission, etc. If directional communication is unsupported, then in step 1216 the data may be transmitted via omnidirectional communication. The process may then return to step 1210 to await additional data for transmission from the apparatus.

If directional communication is supported (e.g., the apparatus can communicate directionally via one or more wireless transports), the process may proceed to optional step 1220 wherein one or more directions from which the data was received may be determined (e.g., data may be received from more than one direction if transmissions are received from more than one other apparatus). This step may be optional in cases where the data was not received (e.g., originated in the apparatus), where the data was received via a transport that does not support directional functionality (e.g., limited to omnidirectional transmission/reception only), etc. The process then moves to step 1222 where transports available for directional data transmission are evaluated. The evaluation in step 1222 may comprise, for example, determining all wireless transports that are capable of transmitting a communication beam in the one or more specific directions, and then selecting at least one preferred transport from amongst the capable transports. The selection of at least one preferred directional transport may be based on various data-related, apparatus-related or environmental-related criteria. For example, transports may be selected based on support in intended recipient apparatuses, noise immunity with respect to interference currently sensed in the operational area, security, speed and/or error correction requirements defined by the data to be transmitted, etc. If no wireless transports are available in step 1224 for transmitting the data in the selected direction, then the process may return to step 1216 in order to transmit the data via omnidirectional communication. If at least one transport is available, then in step 1226 the data may be transmitted via directional wireless communication in the one or more selected directions. In accordance with at least one embodiment of the present invention, transmission in the one or more selected directions (step 1226) may include omitting the one or more directions from which the data was received, per step 1220, since all apparatuses located in this direction would have already received the data. Omitting the one or more directions from which the data was received may help to further reduce overall signal density. The apparatus may then await the next realization of data in step 1210.

If it is determined in step 1212 that the data is intended for specific recipients, then in step 1228 a further determination is made as to whether the intended recipient is just the current apparatus (e.g., the apparatus that received the data). If in step 1228 it is determined that the data was intended only for the current apparatus, then the process may proceed to step 1230 where the data is received (e.g. processed) by the apparatus. In accordance with various example embodiments of the present invention, data transmission terminates since the data has arrived at the intended recipient. The process then returns to step 1210 to await further data realization.

If the intended recipients are not limited to the current apparatus, then in step 1232 a determination may be made as to whether the data is intended for the current apparatus, and further, as to whether directions towards, and/or locations of, the other intended recipients are known (e.g., mapped in current apparatus direction maps). If one or more intended recipients are not mapped (e.g., directions towards, and/or locations of, are determined to be unknown in step 1234), then the process may return to step 1214 for directional determination. For example, one or more preferred directions may be specified based on user/apparatus knowledge regarding where an intended recipient “should” reside or simply as a default setting/configuration. Further, the directions from which the data arrived may still be known, regardless of intended recipient mapping, and these directions should be omitted from future transmissions, if possible, in step 1220. If in step 1234 the locations of, and/or direction towards, the intended recipients are determined to be known (e.g., mapped), then the process may proceed to optional step 1236, or to step 1218 if optional step 1236 is not implemented. Optional step 1236 is an example of logic that may be employed to further refine data transmission. A determination may be made as to whether the data has already been forwarded. This determination may be based on criteria such as, for example, the apparatus from which the data was received, the direction from which the data was received, the wireless transport over which the data was received, etc. The process may then proceed to step 1218 if a determination is made that the data needs to be retransmitted to other apparatuses, or alternatively, if is determined that the data has already been forwarded (e.g., by other apparatuses) the process may return to step 1210 for the next data realization. In this instance the evaluation of step 1222 may comprise, in accordance with at least one example embodiment of the present invention, assigning the one or more selected directions to correspond to the known (e.g., mapped) direction and/or location of the one or more intended recipients. Moreover, as set forth above, the directions from which data was received as determined in step 1220 may be omitted from the one or more selected directions. The resulting one or more selected directions may then be used for directional wireless communication, if available.

In accordance with at least one embodiment of the present invention, directional transmission may be performed utilizing various combinations of connectivity map and direction information. For instance, data that is intended for specific apparatuses may be transmitted in the direction of mapped apparatuses for which the data is not intended. This strategy may be used as, for example, an intermediate step to relay the data to intended recipient apparatuses that are mapped (e.g., through incorporation of direction map information from other apparatuses) but may be out of transmission range of the particular wireless transport being employed by the transmitting apparatus. The actual transmission can even be omnidirectional, but because it is intended for recipients mapped to specific locations, it also “covers” the specific directions.

The various embodiments of the present invention are not limited only to the examples disclosed above, and may encompass other configurations or implementations.

For example, example embodiments of the present invention may encompass apparatuses comprising means for receiving data at an apparatus, means for determining one or more directions from which the data was received, and means for transmitting the data in one or more specific directions excluding the one or more directions from which the data was received.

At least one other example embodiment of the present invention may include electronic signals that cause apparatuses to receive data at an apparatus, determine one or more directions from which the data was received, and transmit the data in one or more specific directions excluding the one or more directions from which the data was received.

Accordingly, it will be apparent to persons skilled in the relevant art that various changes in form and detail can be made therein without departing from the spirit and scope of the invention. The breadth and scope of the present invention should not be limited by any of the above-described example embodiments, but should be defined only in accordance with the following claims and their equivalents.

What is claimed is:

1. A method, comprising:
receiving data at an apparatus;
determining one or more directions from which the data was received; and
transmitting the data in one or more specific directions excluding the one or more directions from which the data was received.

2. The method of claim 1, further comprising determining that the received data is intended for specific recipients or for transmission in one or more specific directions, and if the data is determined to be intended for specific recipients or for transmission in one or more specific directions, determining whether directional communication is supported in the apparatus.

3. The method of claim 2, wherein if directional communication is determined to be supported in the apparatus and the data is determined to be intended for specific recipients, assigning the one or more specific directions to be directions toward the specific recipients from the apparatus.

4. The method of claim 3, wherein transmitting the data in the one or more specific directions occurs if the apparatus first determines that directional communication is supported, and further, that at least one communication transport supported by the apparatus is usable for directional transmission in the one or more specific directions.

5. The method of claim 4, wherein determination that at least one communication transport supported by the apparatus is usable for directional transmission in the one or more specific directions further comprises determining if any of the wireless transports are also supported by the specific recipients.

6. The method of claim 2, further comprising transmitting the data in all directions, excluding the one or more directions from which the data was received, when at least one of the data is not intended for specific recipients or for transmission in one or more specific directions, or if the directions towards the specific recipients are unknown.

7. A computer program product comprising computer executable program code recorded on a computer readable storage medium, the computer executable program code comprising:
computer executable program code configured to receive data at an apparatus;
computer executable program code configured to determine one or more directions from which the data was received; and
computer executable program code configured to transmit the data in one or more specific directions excluding the one or more directions from which the data was received.

8. The computer program product of claim 7, further comprising determining that the received data is intended for specific recipients or for transmission in one or more specific directions, and if the data is determined to be intended for specific recipients or for transmission in one or more specific directions, determining whether directional communication is supported in the apparatus.

9. The computer program product of claim 8, wherein if directional communication is determined to be supported in the apparatus and the data is determined to be intended for specific recipients, assigning the one or more specific directions to be directions toward the specific recipients from the apparatus.

10. The computer program product of claim 9, wherein transmitting the data in the one or more specific directions occurs if the apparatus first determines that directional communication is supported, and further, that at least one communication transport supported by the apparatus is usable for directional transmission in the one or more specific directions.

11. The computer program product of claim 10, wherein determination that at least one communication transport supported by the apparatus is usable for directional transmission in the one or more specific directions further comprises determining if any of the wireless transports are also supported by the specific recipients.

12. The computer program product of claim 8, further comprising transmitting the data in all directions, excluding the one or more directions from which the data was received, when at least one of the data is not intended for specific recipients or for transmission in one or more specific directions, or if the directions towards the specific recipients are unknown.

13. An apparatus, comprising:
at least one processor; and
at least one memory including executable instructions, the at least one memory and the executable instructions being configured to, in cooperation with the at least one processor, cause the device to perform at least the following:
receive data at an apparatus;
determine one or more directions from which the data was received; and
transmit the data in one or more specific directions excluding the one or more directions from which the data was received.

14. The apparatus of claim 13, further comprising determining that the received data is intended for specific recipients or for transmission in one or more specific directions, and if the data is determined to be intended for specific recipients or for transmission in one or more specific directions, determining whether directional communication is supported in the apparatus.

15. The apparatus of claim 14, wherein if directional communication is determined to be supported in the apparatus and the data is determined to be intended for specific recipients, assigning the one or more specific directions to be directions toward the specific recipients from the apparatus.

16. The apparatus of claim 15, wherein transmitting the data in the one or more specific directions occurs if the apparatus first determines that directional communication is supported, and further, that at least one communication transport supported by the apparatus is usable for directional transmission in the one or more specific directions.

17. The apparatus of claim 16, wherein determination that at least one communication transport supported by the apparatus is usable for directional transmission in the one or more specific directions further comprises determining if any of the wireless transports are also supported by the specific recipients.

18. The apparatus of claim 14, further comprising transmitting the data in all directions, excluding the one or more directions from which the data was received, when at least one of the data is not intended for specific recipients or for transmission in one or more specific directions, or if the directions towards the specific recipients are unknown.

19. A system, comprising:
at least one origin apparatus; and
a transmission apparatus;
the transmission apparatus being configured to receive data from the at least one origin apparatus and to determine one or more directions from which the data was received; and
the transmission apparatus being further configured to transmit the data in one or more specific directions excluding the one or more directions from which the data was received.
